(19) United States
(12) Patent Application Publication
(10) Pub. No.: US 2024/0375139 A1
(43) Pub. Date: Nov. 14, 2024

(54) SPRAYING DEVICE AND METHOD FOR SPRAYING A MATERIAL BLANK WITH AN ADHESIVE

(71) Applicant: Lisa Dräxlmaier GmbH, Vilsbiburg (DE)

(72) Inventors: Michael RÖMELSBERGER, Massing (DE); Petra INKOFERER, Vilsbiburg (DE); Ludwig CZAPKA, Loiching (DE); Manuel WITTL, Leiblfing (DE); Martin NIEDERNHUBER, Landshut (DE); Alois MÜLLER, Ergolding (DE); Richard PÖLL, Kumhausen (DE); Heinrich MÜHLHOFER, Vilsbiburg (DE)

(73) Assignee: Lisa Dräxlmaier GmbH, Vilsbiburg (DE)

(21) Appl. No.: 18/781,298

(22) Filed: Jul. 23, 2024

Related U.S. Application Data
(63) Continuation of application No. PCT/EP2023/051598, filed on Jan. 24, 2023.

(30) Foreign Application Priority Data
Jan. 24, 2022 (DE) 10 2022 101 531.9

(51) Int. Cl. B05B 12/16; B05B 12/04; B05B 12/08

(52) U.S. Cl. CPC B05B 12/16; B05B 12/04; B05B 12/085

(57) ABSTRACT

A spray device and a method for spraying a material blank with an adhesive includes a control device; a scanning device, using which a blank feature that characterizes the material blank to be sprayed is recordable, and a corresponding blank-feature data set is providable to the control device. The spray device further includes a conveyor belt using which the material blank to be sprayed is movable along a conveying direction of the conveyor belt through a spray region of the spray device; spray nozzles directed into the spray region, using which the adhesive is sprayable onto the material blank by moving the material blank through the spray region. The spray nozzles are controllable by the control device based on the blank-feature data set. An adhesive layer formed based on the blank feature is generatable on the material blank.

### CROSS-REFERENCE TO RELATED APPLICATIONS

This application is a continuation of International Application No. PCT/EP2023/051598, filed on Jan. 24, 2023, which claims priority to and the benefit of DE 10 2022 101 531.9 filed on Jan. 24, 2022. The disclosure of each of the above-referenced applications is incorporated herein by reference.

### FIELD

The present disclosure relates to a spray device for the spraying of a material blank with an adhesive and a method for the spraying of a material blank, in which the spray device is used.

### BACKGROUND

The statements in this section merely provide background information related to the present disclosure and may not constitute prior art.

Currently, coating a material blank with an adhesive is associated with particularly high expense, in particular when the material blank has different height regions, that is, has a stepped surface. Currently, for example, a roller coating or a complete spraying of the corresponding surface of the material blank is used, which, however, are each associated with disadvantages. If, for example, the entire surface of the material blank is thus coated with the adhesive, a subsequent sewing process, in which the material blank is sewn to another material blank, becomes particularly laborious, since with a needle stroke of the sewing machine whose needle penetrates through the adhesive, the adhesive heats due to the up-and-down movement of the needle and is thereby removed from it. From this results a contaminating of the sewing machine, whereby it must be cleaned at regular intervals, which leads to undesired stoppage times of this sewing machine. Also, with a full-surface coating with the adhesive, a subsequent adhering process becomes particularly laborious, since during the adhering of the material blank, at edge regions or corners the adhesive escapes between the two material blanks to be adhered, whereby the edges are contaminated and a post-processing to remove the escaped adhesive is desired. With a roller coating it can also happen, for example, that the material blank remains adhered on the adhesive-transfer roll and is thereby lifted by the roller, which leads to a malfunction of the roller-coating system. These days the material blank to be coated is attached to a rolling tray, which uses a further additional work step in the coating of the material blank. Furthermore, during the coating of the material blank, the adhesive-transfer roll pushes an adhesive wave crest in front of the adhesive-transfer roll so that an excess of adhesive is present in front of the adhesive transfer roll, which also contaminates the edge of the material blank when the adhesive reaches the edge of the material blank. Therefore, these days a particularly complex stencil technique is used during the rolling of the material section with the adhesive, which once again makes the coating of the material blank by the adhesive-transfer roll more expensive. If the surface of the material blank to be coated furthermore includes unevennesses, an irregular applying of the adhesive thereby arises during the adhesive-roller transfer. Furthermore, the adhesive can seep into open-pore decorations or soft components, which is also undesirable. Furthermore, the adhesive that is supplied to the material blank by the adhesive-transfer roll ages as long as the adhesive is transported on a transfer surface of the adhesive-transfer roll toward the material blank by the adhesive reacting with surrounding air, in particular its water, during the transporting to the material blank, whereby the undesired adhesive properties of the adhesive are influenced. This aging effect also occurs in a roller tank, out of which the adhesive-transfer roller receives adhesive. Overall it is therefore to be recognized that conventional methods for the coating of the material blank with adhesive have economic and ecological disadvantages, since an undesirably high number of reject parts may be produced, and/or a particularly large amount of adhesive is desired.

### SUMMARY

This section provides a general summary of the disclosure and is not a comprehensive disclosure of its full scope or all of its features.

The present disclosure provides a simple and/or inexpensive possibility to efficiently coat different variants of material blanks with an adhesive.

Such material blanks, for example, made of a textile, leather, etc., are used, for example in the domain of an interior fitting of a motor vehicle, in particular automobile. Such material blanks form, for example, a surface in the interior of the motor vehicle. In addition, the present disclosure relates to a method for the spraying of a material blank, in which the spray device is used.

Features, advantages, and possible designs of the spray device are to be viewed, at least in an analogous manner, as features, advantages, and possible designs of the method, and vice versa. If features, advantages, and possible designs of the method are described in the context of the description of the spray device, then they are to be viewed as the same. The same applies in the other direction in an analogous manner.

According to the present disclosure, a spray device is proposed for the spraying of a material blank with an adhesive. The material blank is, for example, a flat textile structure, such as a fabric, a knitting, a knitted fabric, a mesh, a stitch-bonded fabric, a fleece, a felt, etc. Furthermore, the material blank can be a leather, artificial leather, carpet, a plastic film, etc. In particular, the material blank to be coated with the adhesive is flexible or elastic. Furthermore, the material blank can be a rigid element, for example, a metal plate, a plate, etc. A thickness or thickness of the material blank can be between 0.1 mm (millimeters) to 10 mm. A surface, to be coated with the adhesive, of the material blank, that is, an adhesive surface of the material blank, can be flat or uneven, and in particular include stepped height- or thick-regions graduated with respect to one another.

A composite made of the material blank and the adhesive is produced by the coating, in particular spraying, of the adhesive surface. Such a composite is used, for example, in the producing of interior decoration parts for an interior of a motor vehicle, in particular automobile. This means that the composite made of the material blank and the adhesive is connected with a carrier element in a friction-fit-, interference-fit-, and/or material-bonded-manner, in which a surface of the material blank, opposite the adhesive surface and spaced therefrom by a thickness of the material blank, forms a visible surface that is directed toward the interior provided the material blank has been arranged in the installation position as intended. The material blank is adhered, sewn, welded, riveted, for example, with the carrier element.

The adhesive is, for example, a hotmelt, a dispersion adhesive, etc. Thus, for example, a polyurethane- and/or polyolefin-hotmelt (respectively reactive or non-reactive) can be used as adhesive.

The spray device includes a control apparatus, which is in particular an electronic control device, for example, a computer device. The control device is configured to provide control signals for elements of the spray device that are explained in more detail below. For this purpose the control device is coupled or couplable with the corresponding element of the spray device for the transmitting of control signals and/or of data.

In addition, the spray device includes a scanning device, such as an optical scanning device, using which a blank feature that characterizes the material blank to be sprayed is recordable. The scanning device, or a first scanning assembly of the scanning device, can include, for example, a camera, a laser scanner, etc. Here the control device and the scanning device can be coupled or couplable with each other for data transmission, so that using the scanning device, the control device is providable with a corresponding blank-feature data set. This means that the scanning device is configured to provide, for example, to deliver, the blank feature in data form, namely as the blank-feature data set, to the control device. The control device is in particular configured to treat, or to process, or to further process the blank-feature data set as input data. Optionally the scanning device can include a second scanning assembly, that is, a second camera, a second laser scanner, etc., in which the second scanning assembly is configured to record an adhesive-application result and to provide it in data form to a device of the spray device, or a spray-device-external device. It is thus made possible to carry out a particularly efficient, in particular automatic, quality assurance. It is conceivable, for example, that when an insufficient or inadequate adhesive-application result is or has been recorded, the material blank is post-sprayed again with adhesive to improve the adhesive-application result. Such a quality assurance or controlling of the adhesive-application result is in particular advantageous when the material blank is to fulfill a safety-relevant function in its intended installation position, for example, forms a component of an airbag system.

Furthermore, the spray device includes a conveyor belt that is configured to translationally move the material blank to be sprayed along a conveying direction of the conveyor belt or of the spray device through a spray region of the spray device. For this purpose the material blank is placed on an upper run of the conveyor belt, in which an outer upper surface of the upper run and the visible side of the material blank are facing each other and, for example, directly adjacent to each other. This means that the adhesive side of the material blank is facing away from the outer upper surface of the upper run. It is provided that the conveyor belt, in particular a drive unit thereof, and the control device are coupled or couplable with each other for the control-signal transmission and/or data transmission, so that the conveyor belt is controllable or drivable, for example, by the control device. This means that the control device can be configured to regulate, for example, a conveyance- or transport-speed of the conveyor belt.

The conveyor belt is thus a conveyor- or transport-unit, using which the material blank to be sprayed is translationally movable along a conveyor- or transport-unit of the spray device through a spray region of the spray device. Alternatively or in addition to the conveyor belt, the conveyor- or transport-unit can include a rigid, linearly movable plate on whose top side the material blank is placed and which is then moved, for the spraying of the material blank, along the conveying direction through the spray region. For example, this plate can be a tabletop of a so-called shuttle table.

Furthermore, the spray device, in particular its conveyor- or transport-unit, can include a fixing device in order to releasably fix, in a reversible, non-destructive manner, the material blank to be sprayed onto the top side of the plate or onto the upper run of the conveyor belt. For this purpose the fixing device includes, for example, a vacuum- or under pressure-unit, using which the material blank can be fixed under a forming of an under pressure between the plate or the upper run and the material blank.

The spray device furthermore includes spray nozzles that are arranged such that they are directed into the spray region. Furthermore, the spray nozzles are configured to spray the adhesive, under a moving of the material blank through the spray region, onto the material blank, that is, onto its adhesive surface. Here the spray nozzles are controllable or drivable, using the control device, individually or as a group, in particular selectively. The control device is configured to control, based on the blank-feature data set, the (respective) spray nozzle and/or the (respective) spray-nozzle group based on the blank-feature data set. This means that the control device is configured to provide, based on the blank-feature data set, a control signal to each spray nozzle or spray-nozzle group, wherein the respective spray nozzle or spray-nozzle group is configured to accept this control signal, based on the blank-feature data set, as input control signal. In an operation of the spray device, an adhesive layer formed based on the blank feature is thereby generated on the material blank, that is, on its adhesive side. In particular, one or more of the spray nozzles is/are embodied as a contour-edge spray nozzle, as jet spray nozzle, as surface spray nozzle, or as multidot spray nozzle. It is conceivable that the spray device includes at least one contour-edge spray nozzle, and/or at least one jet spray nozzle, and/or at least one surface spray nozzle, and/or at least one multidot spray nozzle. Thus, for example, a surface spray nozzle can be combined with an arbitrary number of contour-edge spray nozzles, a surface spray nozzle with an arbitrary number of jet spray nozzles, or an arbitrary number of jet spray nozzles with an arbitrary number of multidot spray nozzles. A single-type use of corresponding spray nozzles is likewise conceivable, for example, the spray device can include only jet spray nozzles, only multidot spray nozzles, or only contour-edge spray nozzles.

Furthermore, it is also conceivable that the respective spray nozzle is adjustable, and specifically between a contour-edge spray mode, a jet spray mode, and a surface spray mode. Here, for example, the control device is configured for the adjusting of the respective spray nozzle.

The spray device includes in particular an adhesive-supply device, using which the spray nozzles are provided with the adhesive, for example, from an adhesive reservoir. The adhesive-supply device can include a liquefaction device, for example, a heating device or cooling device, using which the adhesive that is to be sprayed onto the adhesive side of the material blank is tempered appropriately in order to produce, maintain, or support a spray ability or atomizability of the adhesive. Because for the spraying of the material blank with the adhesive, the adhesive is provided to the spray nozzles in a sprayable state, that is, in particular liquid. Thus it is true for the operation of the spray device that the adhesive is atomized by the nozzles and, under the atomization or due to the atomizing, is sprayed onto a portion, located in the spray region, of the adhesive side of the material blank.

Using the spray device it is made possible to spray arbitrarily shaped blanks in a contour-precise manner according to an assembly line, and without overspray (portion of an adhesive, sprayed out from spray nozzles, that does not reach provided adhesive regions, but rather reaches an environment thereof), since the spray nozzles directed into the spray region are controlled by the control device in operation, in particular spray operation or coating operation, of the control device based on the blank feature, that is, for example, based on an outer contour of the material blank. For this purpose the spray nozzles, are variably or selectively activatable and/or de-activatable, in particular by the control device. Thus it is possible, for example, to keep an edge region on the adhesive side of the material blank free from adhesive, so that a subsequent connecting process with a carrier element, for example, a sewing or adhering of the material blank onto the carrier element, is designed particularly simply and cost-effectively, since due to the material blank sprayed in a contour-precise manner, no adhesive or only particularly little adhesive penetrates outward at the edges of the material blank between the material blank and the carrier element. If the material blank is sewn with the carrier element and/or another material blank, this is advantageous because the needle of the sewing machine is not contaminated by adhesive in the adhesive-free edge region. Overall the above-described disadvantages of the full-surface coating and of the roller coating are eliminated. In addition, due to the contactless spraying-on of the adhesive (during the spraying-on, the spray nozzles do not come into contact with the material blank to be sprayed) there are no limitations with respect to decoration shape and with respect to tolerances, in particular thickness tolerances, of the material blank. In particular an adhesive guidance system of the spray device is embodied as closed system, which means that the adhesive is not exposed to the environmental air until it is sprayed by the spray nozzles.

Using the spray device it is furthermore advantageously made possible to uniformly spray a multi-step or graduated adhesive surface of the material blank with the adhesive so that independent of a local thickness region of the material blank, a uniform application with adhesive is formed on the entire adhesive surface of the material blank.

In general it can be true for the spray device that at least the conveyor belt and the spray nozzles are collected into a module. In further design of the spray device it is provided that the scanning device includes an external scanning unit for the recording of the state feature. This means that in this case the scanning device includes the external scanning unit, which is arranged outside the module made of the conveyor belt and the spray nozzles. For example, the external scanning unit can be used at a different location than the module, including the conveyor belt and the spray nozzles, of the spray device. Thus it is made possible, for example, in operation of the spray device, to scan the material blank using the scanning device and thereby to record the blank feature, then to bring the material blank to the module and place it on the upper run of the conveyor belt so that the material blank is then moved through the spray region by the conveyor belt, in which the adhesive surface of the material blank is sprayed with the adhesive by the spray nozzle. Due to such a modular construction of the spray device, it is usable in a particularly versatile or flexible manner, and in particular adaptable to infrastructure constraints.

Alternatively or in addition to the external scanning unit, in a further design the scanning device includes an internal scanning unit for the recording of the state feature. For example, the spray nozzle thus incudes a module in which the conveyor belt, the spray nozzles, and the internal scanning unit are collected. In this way the spray device is configured particularly compact, and transport paths for the transporting of the material blank from the scanning device or the external scanning unit to the conveyor belt are avoided.

In further development the internal scanning unit includes a straight scanning bar that is disposed over and perpendicular to the conveying device or transport device of the conveyor belt. Here the scanning bar or the internal scanning unit is arranged at an input side of the spray device before the spray region. For the operation of the spray device, this means that the material blank first passes the straight scanning bar, for example, using the conveyor belt, in order to then subsequently be moved into and through the spray region. It can be provided, for example, that the upper run of the conveyor belt extends completely below the spray region and completely below the straight scanning bar. The spray device is therefore particularly simply constructed, since only a single conveyor belt is desired in order to move the material blank, in operation of the spray device, under the scanning unit and through the spray region.

According to a further example of the spray device, the control device is configured, that is, arranged and disposed, to control the spray nozzles such that one or more of the following spray parameters is/are adjustable for the generating of the adhesive layer:

a material blank region to be kept free of adhesive, for example, an edge region;

an adhesive quantity (for example, an adhesive volume, an adhesive mass, etc.) per surface portion of the material blank, for example, a local adhesive layer thickness;

an adhesive spray nozzle, with which the adhesive is atomized and/or applied onto the adhesive side;

an adhesive spray temperature, at which the adhesive is tempered for the atomizing, and/or at which the adhesive exits from the spray nozzles.

The spray device is thus configured to set the spray parameter or the spray parameters as needed or appropriate to the situation, based on the blank-feature data set, that is, based on the blank feature. Using the spray device a variety of different adhesive-layer variants are thereby generatable, whereby the particularly versatile or flexible use spectrum of the spray device is supported once more.

A further form of the spray device provides that at least some of the spray nozzles are collected into a (first) straight spray-nozzle bar. This means that the spray device includes the first straight spray-nozzle bar on which the at least some of the spray nozzles are disposed spaced equidistant from one another along a longitudinal extension direction of the spray-nozzle bar. Here the spray-nozzle bar is disposed perpendicular to the supply direction over the conveyor belt, in particular over its upper run. In operation, in particular spraying operation, of the spray device, the material blank resting on the upper run of the conveyor belt is thus moved perpendicular to the longitudinal extension direction of the spray-nozzle bar under the spray nozzle bar, and is sprayed here with the adhesive using the spray nozzles. There the spray nozzles that are arranged together on the first spray-nozzle bar are controllable by the control device together, or groupwise, or individually, so that, for example, a material blank that is shorter than the longitudinal extension of the spray-nozzle bar can be sprayed with the adhesive in a contour-precise manner by only some of the spray nozzles arranged on the first straight spray-nozzle bar dispensing adhesive. This means that the control device and the spray-nozzle bar are coupled or couplable with each other for data transfer and/or control-signal transfer. Here the spray-nozzle bar or the spray nozzles arranged along the spray-nozzle bar are configured to accept the control signals provided by the control device as input control signals. In particular, the spray-nozzle bar on which the spray nozzles are arranged spaced equidistantly from one another along a common straight line is long enough that it spans a total width of the upper run perpendicular to the transport direction or conveying direction of the conveyor belt. Furthermore, it is provided in particular that the spray-nozzle bar and the internal scanning unit or the straight scanning bar are arranged parallel to each other. In general it applies for the spray device—thus also for the spray-nozzle bar—that the spray nozzles can be oriented vertically on the upper run of the conveyor belt. Using the spray-nozzle bar it is provided that—when the material blank is moved through the spray region by the conveyor belt—the material blank can be sprayed with the adhesive in a contour-precise manner particularly efficiently and without formation of gaps in the adhesive coating.

In a further possible design of the spray device, it includes at least one further (for example, second) straight spray-nozzle bar, which can be configured analogously to the above-described first spray-nozzle bar. Accordingly on the second spray-nozzle bar, further or other of the spray nozzles are disposed spaced equidistant from one another along a longitudinal extension direction of the second spray-nozzle bar, in which the second spray-nozzle bar is disposed perpendicular to the conveying direction or transport direction over the conveyor belt. The spray nozzles arranged on the second spray-nozzle bar are in particular arranged along a common straight line along the longitudinal extension direction of the second spray-nozzle bar. Thus, if both the first straight spray-nozzle bar and the second straight spray-nozzle bar are used in the spray device, it is provided in particular that the two spray-nozzle bars are offset with respect to each other along their respective longitudinal extension direction, that is, perpendicular to the conveying direction of the conveyor belt, such that between two spray nozzles that are directly adjacent to each other on one of the common spray-nozzle bars, one of the spray nozzles of the other spray-nozzle bar is disposed. A particularly high spray resolution, and consequently a particularly accurate or contour-precise spraying of the material blank with the adhesive is provided. In order to increase the spray resolution even further, a still further (or third) straight spray-nozzle bar can be provided that is configured and arranged analogously to the first or second spray-nozzle bar. Perpendicular to the conveying direction of the conveyor belt, the first straight spray-nozzle bar, the second straight spray-nozzle bar, and the third straight spray-nozzle bar are then offset with respect to one another such that between two spray nozzles that, for example, are attached together on the first spray-nozzle bar and directly adjacent to each other, both one of the spray nozzles of the second spray-nozzle bar and one of the spray nozzles of the third spray-nozzle bar are arranged. This principle can be further developed by a further increasing of the number of spray-nozzle bars, whereby a higher spray quality, in particular a higher spray resolution, is respectively achieved. Particularly geometrically complexly configured regions of the material blank can thereby be particularly accurately or contour-precisely sprayed with the adhesive.

It can be provided that the spray-nozzle bars are controlled by the control device individually or groupwise in the operation of the spray device. For this purpose it can be provided, for example, that the control device is coupled or couplable with the respective spray-nozzle bar for the transmitting of control signals and/or of (other) data. It can further be provided that the spray-nozzle bars are collected into a spray-nozzle-bar module that accepts as input control signals the control signals provided by the control device, so that the spray-nozzle bars of the module are controllable by the control device individually or groupwise.

It is also conceivable that the spray device includes a gantry robot, controllable by the control device, whose crossbar is disposed perpendicular to the conveying direction over the conveyor belt. On the crossbar at least one of the spray nozzles is supported in a translationally movable manner, so that the spray nozzle is translationally movable perpendicular to the conveying direction between longitudinal edges of the conveyor belt. The spraying of the material blank with the adhesive then occurs, for example, as follows: under a through-movement of the material blank resting on the conveyor belt, the gantry robot or the spray nozzles of the gantry robot are controlled by the control device, in which the adhesive—similar to the principle of a plotter—is sprayed onto the material blank in a contour-precise manner. For this purpose the spray nozzle is moved along the crossbar for the spraying of the material blank. Optionally the crossbar can be translationally movably supported along the conveying direction on a longitudinal rail of the gantry robot, in which for the spraying of the material blank with the adhesive the spray nozzle can thus be moved along the conveying direction and perpendicular to the conveying direction. Alternatively or in addition to the gantry robot a jointed-arm robot is conceivable whose distal end limb includes the spray nozzle or spray nozzles. In the case of the jointed-arm robot, it is conceivable in particular that the conveyor belt is omitted.

The spray device can include a replacement spray-nozzle magazine in which a replacement spray nozzle or a plurality of replacement spray nozzles are stored. Here the replacement spray-nozzle magazine is in particular disposed in the immediate vicinity of the installed spray nozzles. In the case that the spray device includes the jointed-arm robot, it can be provided that it automatically, that is, without assistance from a human worker, exchanges the spray nozzle installed on its end limb with a replacement spray nozzle from the replacement spray-nozzle magazine. For this purpose a wear- and/or contamination-detection can be provided in the spray device in order to exchange the installed spray nozzle with a replacement spray nozzle with a reduction in time. The wear- and/or the contamination-detection can be affected, for example, indirectly, for example, by being recorded by the control device that the material blank must be post-sprayed again with adhesive multiple times for the improvement of the adhesive application result, and/or a plurality of material blanks must be respectively post-sprayed again with adhesive to improve the adhesive application result. This can determine a wear and/or a contamination of the spray nozzle. A direct wear, and/or contamination detection, for example, by a correspondingly configured sensor system, is likewise easily conceivable.

In a further form of the spray device, the respective spray nozzle includes a nozzle outlet that is configured such that a spray cone is realized at a prescribed distance from the nozzle outlet, and the diameter of the spray cone measures between 1 mm to 4 mm, in particular between 2 mm to 3 mm. For this purpose particularly small spray nozzles are used, in which they are in particular spray nozzles that are smaller than spray nozzles that are used in conventional spray devices. This means that the respective nozzle outlet in the spray device is smaller than in spray devices of the prior art. Due to the particularly small spray-cone diameter, the concept of a particularly contour-precise spraying of the material blank, in particular with geometrically complicated design of the material blank, is particularly taken into account. The prescribed distance in which starting from the nozzle outlet the diameter of the spray cone is measured, corresponds here in particular with the distance over which during the spraying of the material blank, its adhesive side is vertically spaced from the nozzle outlet. In other words, the spray nozzles or their nozzle outlet are configured such that on the adhesive side of the material blank the spray-cone diameter measures between 1 mm to 4 mm, in particular between 2 mm to 3 mm. It can furthermore be provided that the nozzle outlets of the spray nozzles are adjustable in order to be able to adjust the spray-cone diameter—in particular steplessly—between the mentioned values.

The blank feature of the material blank includes at least one partial feature or a variety of partial features. A “partial feature” is, for example, an outer-circumference contour of the respective material blank. The partial features include, for example, an opening contour of an opening penetrating the material blank, in particular an opening completely penetrating the material blank, i.e. a through-opening. A further partial feature can be formed, for example, by a code arrangement, in particular a machine-readable code arrangement. In other words, the state feature of the corresponding material blank includes one or more of the partial features described above. According to a further form of the spray device, it is now provided that the scanning device is configured to record the blank feature of one or more of the partial features of the material blank. In this respect the scanning device is therefore configured to record the outer-circumference contour and/or the opening contour of the opening and/or the code arrangement in order to record the blank feature of the material blank. Furthermore, the scanning device is configured to provide the blank-feature data set to the control device based on the partial features. It is furthermore conceivable that for each recorded partial feature, the scanning device provides a partial-feature data set characterizing the respective partial feature, in which the control device is then configured to create the blank-feature data set from the partial-feature data sets or from the at least one partial feature data set, and to further process it in accordance with the above description. By the scanning device being configured to record the respective partial feature of the material blank, a variety of different adhesive variations can be generated, for example on geometrically identically configured material blanks that differ from one another, for example, due to the opening contour and/or due to the code arrangement. Furthermore, due to the recording of the outer-circumference contour of the respective material blank, geometrically differently configured material blanks can respectively be sprayed with the adhesive in a contour-precisely-adapted manner, in particular without a manual intervention of a worker or user of the spray device.

The code arrangement of the material blank includes a code element or a plurality of code elements, so that the code arrangement of the material blank can be formed by the code element or the code elements. One of the code elements can be, for example, an edge-notch arrangement including at least one edge notch. The respective edge notch can be pinched out of the edge of the corresponding material blank, for example, using a pinching tool. Furthermore, a cutting-out, stamping-out, etc. of the corresponding edge notch is conceivable. A further code element can be formed, for example, by a barcode. In addition, a further of the code elements can be formed by a QR code. Accordingly in a further form of the spray device, the scanning device is configured for the recording of the code arrangement of at least one or more of the above-described code elements of the material blank. The code arrangement is configured at least partially machine-readable, in which the edge notch arrangement, the barcode, and the QR code are each machine-readable code elements of the code arrangement. In this respect the scanning device includes means to mechanically read or record the code arrangement, that is, the edge notch arrangement and/or the barcode and/or the QR code. The code elements here are to be viewed as a (respective) data carrier, so that with a mechanical reading or recording of the code elements using the scanning device, these data can be provided to the control device. This means that the control device is configured to process or to further process the data of the data carrier or of the code elements or of the code arrangement, in particular to process or to further process into control signals for the spray nozzles. In this respect it is conceivable with the spray device that the spray nozzles are controlled based on the data of the code elements. It can be provided here, for example, that the data that are stored using the code elements on/in the material blank to be sprayed with the adhesive characterize the material-blank region to be kept free of the adhesive, the amount of adhesive per surface portion of the material blank, the adhesive spray pressure and/or the adhesive spray temperature, that is therefore the spray parameters. Furthermore, it is conceivable that using one or more of the code elements of the material blanks, its geometric outer-circumference contour and/or the opening contour of the opening at least partially penetrating the material blank is/are characterized. In this way a particularly reliable and contour-precise or accurate spraying of the material blank with the adhesive is provided. In particular, the spray parameters under which the adhesive is sprayed onto the material blank or onto its adhesive side, are recorded with particular certainty and failure resistance by the scanning device, and provided to the control device.

In a further development of the spray device it is provided that a hot-air blower is disposed behind the spray region at an output side of the spray device. For an operation of the spray device this means that the material blank that is/has been sprayed with the adhesive is transported out of the spray region by the conveyor belt and is then or thereby transported into a hot-air-blower region in which the compound made of the material blank and the adhesive layer is blown with warm or hot air by the hot-air blower. Using the hot-air blower it is made possible, for example, to thermally influence so-called spiderweb transitions, which can arise in particular on height gradations or thickness gradations of the material blank during the spraying of the adhesive, such that the spiderweb transitions are eliminated. For example, due to the warm air or hot air supplied by the hot-air blower, the adhesive of the respective spiderweb transition is softer, for example, melted, so that the adhesive of the corresponding spiderweb transition abuts in a desired manner against the contour of the material blank or its thickness transition or thickness step. Overall, in operation of the spray device the hot-air blower serves, for example, to normalize the adhesive layer, whereby the generating of the particularly uniform adhesive layer on the adhesive side of the material blank is once again supported. The hot-air blower thus serves, for example, to thermally treat the adhesive layer that has been sprayed onto the material blank, for example, in order to melt individual spray points and/or spray regions, so that these merge into one another, whereby in an advantageous manner the adhesive layer is particularly thick on the adhesive side of the material blank.

Alternatively or in addition to the hot-air blower, it is provided—in a possible further form of the spray device—that a cold-air blower is disposed at the output side of the spray device, in particular behind the hot-air blower (if present). The cold-air blower is configured to, in operation of the spray device, to cool down the adhesive layer that has been applied onto the adhesive side of the material blank, for example, since the adhesive can be heated up for particularly efficient atomizing or spraying by the spray nozzles. If the hot-air blower is used in the spray device, the adhesive layer, and consequently the material blank or the composite made of the adhesive layer and the material blank, are heated even more, so that in this case the cold-air blower is alternatively or additionally configured to cool off the composite made of the adhesive layer and the material blank, which has been heated by the hot-air blower. The purpose of the cold-air blower is therefore to lower, as efficiently as possible, a temperature of the adhesive layer and/or of the material blank so that the material blank together with its adhesive layer can be handled (again) particularly soon after the spraying. For this purpose the spray device includes, for example, a cold-air region into which the cold-air blower is directed, so that the material blank moved through the cold-air region is cooled by the cold-air blower. The hot-air region and/or the cold-air region can be, similarly to the straight scanning bar and/or the (respective) spray-nozzle bar, arranged perpendicular to the conveying direction or transport direction of the conveyor belt and completely span it in its width. This means that the upper run of the conveyor belt can extend along the conveying direction completely under the straight scanning bar, completely under the spray nozzles or spray-nozzle bar, completely under the hot-air region or under the hot-air blower, and completely under the cold-air region or under the cold-air blower. This means that the spray device in particular includes a single conveyor belt.

With the spray device it is furthermore conceivable that the hot-air blower and/or the cold-air blower are/is controllable using the control device. In this respect the hot-air blower and/or the cold-air blower and the control device are/is coupled or couplable with one another for the transmitting of control signals.

In a further possible form, the spray device includes a drying device that is disposed behind the spray region at the output side of the spray device in order to dehumidify the adhesive layer. After the spraying process, the adhesive of the adhesive layer initially still has, in particular with the use of a dispersion adhesive, a particularly high water content, for example, approximately 50 percent water, due to which the composite made of the adhesive layer and the material blank must be temporarily stored for drying prior to a further processing. Using the drying device, a duration between the spraying-on of the adhesive layer and a possible further processing is significantly shortened, whereby a serial spraying of material blanks with the adhesive is supported.

In a further aspect, the present disclosure relates to a method for the spraying of the material blank with the adhesive using a spray device configured according to the above description. In the method the material blank is thus sprayed with the adhesive by the spray device. For this purpose the material blank is scanned by the external scanning unit and/or by the internal scanning unit, in which the blank features of the corresponding material blank are recorded and provided to the control device. Not later than after the scanning or recording of the blank feature, the material blank is placed with its visible side on the outer surface of the upper run of the conveyor belt, using which the material section is transported toward the spray region of the spray device. By a moving of the material blank through the spray region, the adhesive side of the material blank is sprayed with the adhesive by the spray nozzles. Here the spray nozzles are controlled by the control device based on the blank feature or based on the blank-feature data set such that based on the blank-feature or based on the blank-feature data set, the adhesive layer is generated on the material blank. Since different material-blank variants have a different blank feature, in the spray device or in a method it is provided in particular that based on the respective material-blank variant, that is, based on the associated blank feature, a different adhesive layer is determined that is formed on the adhesive side of the material blank. In other words, the spray device is configured to form or to generate a different variant of an adhesive layer for each material-blank variant.

Further advantages, features, and details of the present disclosure can arise from the following description of possible examples, as well as based on the drawings. The features and feature combinations mentioned in the above description as well as the features and feature combinations shown below in the Figure description and/or in the Figures alone are usable not only in the respectively specified combination, but rather also in other combinations or alone, without departing from the context of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic view of a spray device for the spraying of a material blank with an adhesive according to the present disclosure;

FIG. 2 shows a schematic view of possible material-blank variants according to the present disclosure; and

FIG. 3 shows a schematic and cut view of the material blank that includes different thickness regions, that is, a stepped adhesive side according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

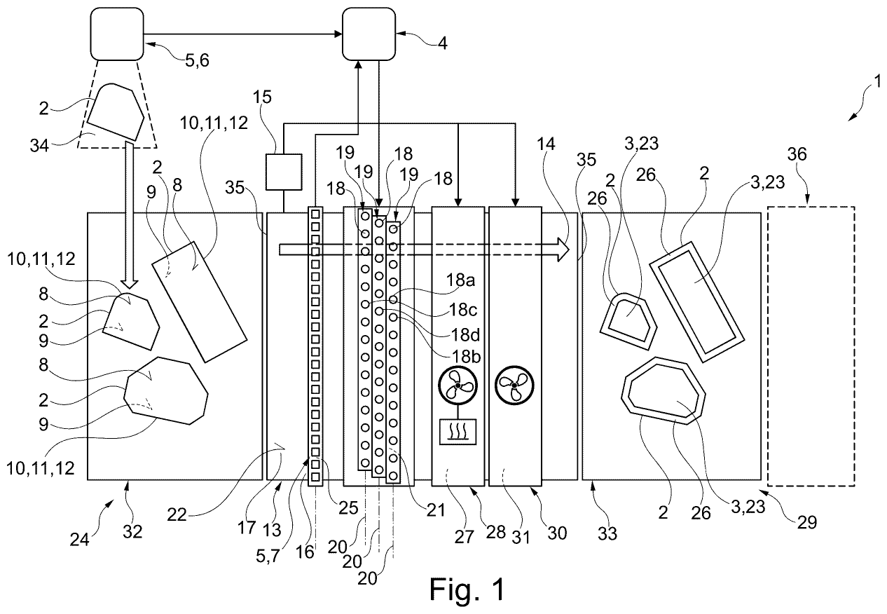

In the following a spray device 1 and a method are presented in a common description, each for the spraying of a material blank 2 with an adhesive 3. For this purpose FIG. 1 shows a schematic view of the spray device 1 for the spraying of the material blank 2 with the adhesive 3. The spray device 1 includes a control device 4 that is configured as an electronic control device, that is, as a computer device. The spray device 1 further includes a scanning device 5 that in the present example includes an external scanning unit 6 and an internal scanning unit 7. The scanning device 5, that is, the scanning units 6, 7, are coupled for data transfer with the control device 4 in a wireless and/or wired manner. The respective scanning unit 6, 7 includes in particular at least one camera and/or at least one laser scanner or the like. It is further provided in the present case that the external scanning unit 6 and/or the internal scanning unit 7 each includes/include a first scanning assembly and a second scanning assembly.

The respective material blank 2 has an adhesive side 8 and a visible side 9 that are spaced from each other by a thickness or thickness of the material blank 2 and are set against each other or facing away from each other. Furthermore, the respective material blank 2 includes a blank feature 10 that is formed from at least one partial feature 11. Presently a first partial feature 11 of the blank feature 10 of the respective material blank 2 is formed by an outer-circumference contour 12 of the respective material blank 2. Based on the intrinsic information of the respective blank feature 10, a respective variant of the material blank 2 is characterized or identifiable, in which the scanning device 5 is configured to record the respective blank feature 10 of the material blank 2. For the method for the spraying of the material blank 2 with the adhesive 3, this means that the material blank 2 to be sprayed is scanned by the scanning device 5, whereby the blank feature 10 of the corresponding material blank 2 is recorded. The scanning device 5 is furthermore configured to provide a corresponding blank-feature data set to the control device 4. Accordingly in the method for the spraying of the material blank 2, the material-blank feature data set is provided to the control device 4. The material-blank feature data set includes the data by which the blank feature 10, and consequently the material blank 2, is characterized.

The spray device 1 furthermore includes a conveyor- or transport-unit, configured in the present example as conveyor belt 13, which is configured to move or to transport the material blank 2 along a conveying direction 14 of the conveyor- or transport-unit, that is, of the conveyor belt 13, or of the spray device 1. For this purpose the conveyor- or transport-unit or the conveyor belt 13 in the present case includes a drive unit 15 that is controllable or drivable, for example, by the control device 4.

In the present example the internal scanning unit 7, in particular its first scanning assembly, is configured as a straight scanning bar 16 or includes this straight scanning bar 16. The straight scanning bar 16 is—as shown in FIG. 1—arranged perpendicular to the conveying direction 14 above an upper run 17 of the conveyor belt 13 and spaced therefrom.

The spray device 1 further comprises a variety of spray nozzles 18, of which for reasons of clarity only a small number are provided with the corresponding reference numbers in FIG. 1. The respective spray nozzle 18 is configured to atomize the adhesive 3. In particular, one or more of the spray nozzles 18 is/are configured as a contour-edge spray nozzle, as jet spray nozzle, as surface spray nozzle, or as multidot spray nozzle. One or more of the spray nozzles 18 is/are, for example, attached to a gantry robot and/or jointed-arm robot of the spray device 1. In the present example the spray nozzles 18 are distributed over three spray-nozzle bars 19 that are each arranged perpendicular to the conveying direction 14 of the conveyor belt 13. Here the spray nozzles 18 of the respective spray-nozzle bar 19 are disposed in a straight line along a respective longitudinal extension direction 20 of the respective spray-nozzle bar 19, and are spaced equidistantly from one another here. The spray-nozzle bars 19 are offset from one another along the respective longitudinal extension direction 20, in which the spray-nozzle bars 19 can be configured identically, in particular can include an identical number of spray nozzles 18. This causes that both a spray nozzle 18c of the spray-nozzle bar 19 shown on the left in FIG. 1 and a spray nozzle 18d of the spray-nozzle bar 19 shown in the middle of FIG. 1 are disposed between two spray nozzles 18a, 18b, directly adjacent to each other, of the spray-nozzle bar 19 shown on the right in FIG. 1.

The respective spray nozzle 18 is directed—in particular perpendicularly—into a spray region 21 of the spray device 1, which spray region 21 extends from an outer surface 22 of the upper run 17 up to a respective nozzle outlet (not shown). In other words, the spray region 21 is disposed between the spray nozzles 18 and the upper run 17.

The spray nozzles 18, that is in the present case the spray-nozzle bars 19, are controllable by the control device 4, since the spray nozzles 18 or spray-nozzle bars 19 and the control device 4 are connected with each other in a wireless or wired manner. Thus the spray device 1 is configured to atomize the adhesive 3 using the spray nozzles 18, and to spray it onto the material blank 2, in particular onto its adhesive side 8, in which the material blank 2 is moved translationally along the conveying direction 14 by the conveyor belt 13 through the spray region 21 of the spray device 1. Here the spray nozzles 18 (and/or in particular the robot/robots of the spray device 1) are controlled by the control device 4 based on the blank-feature data set or based on the blank feature 10 such that an adhesive layer 23 is generated on the material blank 2 that has been determined or ascertained based on the blank feature 10. In the method for the spraying of the material blank 2, the material blank 2 is thus scanned by the scanning device 5, that is, by the external scanning unit 6 and/or using the internal scanning unit 7, in order to record the blank feature 10 of the material blank 2 to be sprayed and provide the corresponding blank-feature data set to the control device 4. If the material blank 2 is scanned by the external scanning unit 6, after the scanning or recording of the blank feature 10, the transporting follows of the material blank 2 to an input side of the spray device 1. If the scanning of the material blank 2 occurs using the internal scanning unit 7, the material blank 2 that is moved under the straight scanning bar 16 by the conveyor belt 13 passes through a scanning region 25 of the spray device 1, in which the blank feature 10 of the material blank 2 is recorded by the scanning device 5, in particular by the scanning bar 16. For this purpose the scanning bar 16 or the internal scanning unit 7 is arranged at the input side 24 of the spray device 1 before the spray region 21. With a further movement or further transporting of the material blank 2 out of the scanning region 25, the material blank 2 is then moved by the conveyor belt 13 into the spray region 21 or through the spray region 21, in which the adhesive 3 is sprayed onto the adhesive side 8 of the material blank 2 by the spray nozzles 18, in particular by the spray-nozzle bars 19. Here the spray nozzles 18 are controlled by the control device 4 such that the adhesive layer 23 is formed based on the blank feature 10. For this purpose the spray nozzles 18 (and/or in particular the robot/robots of the spray device 1) are controllable by the control device 4 based on the blank-feature data set such that one or more of the following spray parameters for generating the adhesive layer 23 is/are adjustable:

a material-blank region 26 to be kept free of the adhesive 3, for example, edge region of the material blank 2;

an amount of adhesive 3 per surface portion of the material blank 2;

an adhesive spray pressure; and

an adhesive spray temperature.

The spray nozzle 18 includes a nozzle outlet that is configured such that a spray cone is realized at a prescribed distance from the nozzle outlet, the diameter of the spray cone measures between 1 mm to 4 mm, in particular between 2 mm to 3 mm.

In the present example the spray device 1 is configured such that the material blank 2 sprayed with the adhesive 3, which material blank 2 is transported out of the spray region 21, is thereby or thereafter transported into a hot-air region 27 of the spray device 1. The hot-air region 27 is arranged between the upper run 17 of the conveyor belt 13 and a hot-air blower 28 of the spray device 1 so that the upper run 17 and the hot-air blower 28 are spaced from each other by a height of the hot-air region 27.

The hot-air blower 28 is disposed at an output side 29 of the spray device 1 and behind the spray region 21 with respect to the conveying direction 14 of the spray device 1 or of the conveyor belt 13, so that in operation of the spray device 1, that is, during the method for the spraying of the material blank 2, the material blank 2 is transported by a moving-out from the spray region 21 toward the hot-air blower 28.

In particular, before the hot-air region 27 a monitoring or quality check of the adhesive-application result can be carried out. For this purpose, in particular the second scanning assembly of the internal scanning unit 7 and/or the second scanning assembly of the external scanning unit 6 are used. Using the second scanning assembly, the adhesive-application result is then recorded and this is provided in data form to the control device 4. When it is determined by the control device 4 that an insufficient or inadequate adhesive-application result is present, the material blank 2 is post-sprayed once more with adhesive 3 to improve the adhesive-application result. For this purpose the conveyor belt 13 can be driven in particular in a backward direction in order to transport the material blank 2 to the post-spraying against conveying direction 14 through the spray region 21, where the material blank 2 is post-sprayed with adhesive 3.

In the present case the spray device 1 furthermore includes a cold-air blower 30, and consequently a cold-air region 31, that are arranged at the output side 29, in particular behind the hot-air blower 28 or hot-air region 27, and/or after the monitoring of the adhesive-application result. By a moving of the material blank 2 by the conveyor belt 13, the material blank 2 is thus moved out of the spray region 21, in particular out of the hot-air region 27, and toward the cold-air region 31 or toward the cold-air blower 30. The hot-air blower 28 and/or the cold-air blower 30 are in particular connected with the control device 4 so that the hot-air blower 28 and/or the cold-air blower 30 are/is controllable by the control device 4.

In FIG. 1 an input-side transport element 32 and an output-side transport element 33 are shown, in which the respective transport element 32, 33 can be, for example, a respective transport table (“shuttle”). The transport elements 32, 33 can be viewed as part of the spray device 1. The input-side transport element 32 or the input-side shuttle is used, for example, in the operation of the spray device 1 or during the method for the spraying of the material blank 2, to transport the material blank 2 to be sprayed from the scanning region 34 associated with the external scanning unit 6 to the input side 24 of the spray device 1. At the input side 24 or at the output side 29 of the spray device 1 a respective end of the conveyor belt 13 is disposed, in which the ends 35 of the conveyor belt 13 are spaced from each other along the conveying direction 14. Here in an alternative form, the respective transport element 32, 33 can be formed by the conveyor belt 13 itself.

In addition, the transporting of the material blank 2 between the input side 24 and the output side 29 can be affected by a shuttle table. This can be provided alternatively or in addition to the conveyor belt 13. In this respect the conveyor- or transport-unit of can include one or more conveyor belts 13. Alternatively, thereto the conveyor- or transport-unit can include the shuttle table or more shuttle tables. Alternatively in turn the conveyor- or transport-unit can include both at least the one shuttle table and at least the one conveyor belt 13.

At the output side 29, in the present example the spray device 1 includes a drying device 36, using which the adhesive layer 23 can be dehumidified. Here the drying device 36 can connect directly to the spray region 21, or be arranged after the hot-air blower 28 or after the cold-air blower 30. In the present case it is shown in FIG. 1 that the drying device 36 is fed with the sprayed material blanks 2 by the sprayed material blanks 2 being transported by the output-side transport element 33 (i.e., for example, by the conveyor belt 13) to the drying device 36.

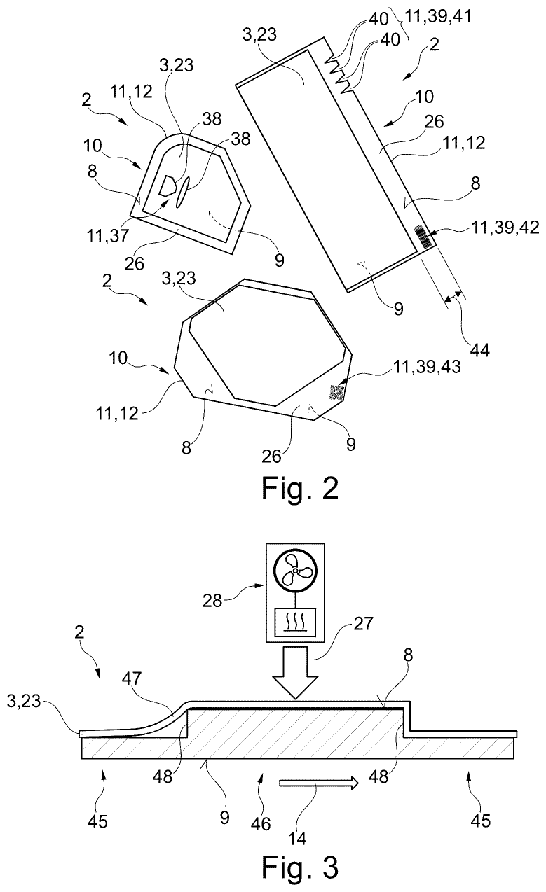

FIG. 2 shows—merely by way of example and by no means conclusively—a schematic view of possible variants of material blanks 2, which include a respective variant of the blank feature 10. As already described above, the respective blank feature 10 is formed from one or more partial features 11, wherein one of the partial features 11 is the respective outer-circumference contour 12 of the corresponding material blank 2. In FIG. 2 it can now be seen that the respective blank feature 10 can include a further partial feature 11, in which it can be, for example, an opening contour 37 of an opening 38, for example, completely penetrating the material blank 2. A positional location of the respective opening 38 or of the respective opening contour 37, for example, with respect to a prescribed or prescribable source of the material blank 2, can also be considered during the recording of the partial feature 11 or of the opening contour 37.

A still further partial feature 11 of the material blank 2 can furthermore be a code arrangement 39, which, for example, comprises an edge-notch arrangement 41 including at least one edge notch 40, a barcode 42, and/or a QR code 43. In any case the respective code arrangement 39 is machine-readable, that is, for example, scannable using the scanning device and/or recordable and/or interpretable using the scanning device 5, in which respective data stored in the respective code arrangement 39 can be read. For example, using a number of the edge notches 40 of the edge-notch arrangement 41, an edge-region width 44 of at least one edge of the material blank 2 can be determined by multiplying a prescribed or prescribable base value, for example, 1 mm, with the number of the edge notches 40, and the edge-region width 44 results therefrom. In the present case, this means for the material blank 2 that the edge-region width 44 is 4 mm, since the edge-notch arrangement 41 has, for example, four edge notches 40. Alternatively or additionally the edge-region width 44 can be stored in data form in the barcode 42 and/or in the QR code 43.

FIG. 3 shows a schematic and cut view of the material blank 2 that includes different thickness regions 45, 46, that is, a stepped adhesive side 8. During the spraying of the adhesive side 8 of the material blank 2 with the adhesive 3 so-called spiderwebs 47 can result, in which a portion of the adhesive 3 forming the respective spiderwebs 47 undesirably does not lie directly on the adhesive side 8 of the material blank 2. This can occur in particular at locations at which the thickness regions 45, 46 border each other by a step 48, which can in particular be vertical. In order to rectify these undesirable spiderwebs 47, so that the adhesive layer 23 abuts particularly closely directly against the adhesive side 8, the hot-air blower 28 is provided, using which the portion of the adhesive 3 forming the respective spiderwebs 47 is heated, whereby that portion of the adhesive 3 softens and then, in particular supported by an air stream generated by the hot-air blower 28 and directed against the adhesive 3, abuts completely against the adhesive side 8 of the material blank 2.

It can happen that the material blank 2 to be sprayed that rests on the upper run 17 moves in an undesired manner due to the spraying with the adhesive 3, since the spraying results in air movements in the spray region 21. For example, the material blank 2 could be displaced on the upper run 17, and/or due to the air movements edges of the material blank 2 could be underreached by air and lifted from the upper run 17. In order that the material blank 2 does not move and/or deform in an undesirable manner during spraying or during passing through the spray device 1, in the method for the spraying of the material blank 2 it can be provided that the material blank 2 is releasably fixed on the outer surface 22 of the upper run 17 in a reversible, non-destructive manner, for which purpose in the present example the spray device 1 includes a fixing device (not shown), which, for example, comprises an under-pressure unit so that under formation of an under-pressure between the visible side of the material blank 2 and the upper run 17, the material blank 2 is or will be fixed on the upper run 17. Here it can be provided, for example, that for the providing of the under-pressure on the visible side of the material blank 2, the conveyor belt 13 is perforated. Furthermore, the fixing device can include an auxiliary adhesive coating, for example, double-sided adhesive tape, via which the visible side 9 of the material blank 2 and the upper run 17 are or will be releasably connected with each other in a non-destructive manner. Furthermore, a hook device made of a hook portion and a fleece portion is conceivable as, for example, a further fixing unit, using which the material blank 2 and the conveyor belt 13 can be connected with each other.

In order to avoid an adhering or clogging of the spray nozzles 18 with adhesive 3, for example, at an end of a work shift, the method for the spraying of the material blank 2 can include a rinse cycle in which the respective spray nozzle 18 is rinsed-through with a non-sticky fluid, for example, air, water, a special cleaning liquid (such as an adhesive solvent) etc., so that an adhesive residue does not harden in one or more of the spray nozzles 18 in an undesirable manner and then render them in an undesirable manner inoperative.

By the spray device 1 and by the method a particularly simple and/or low-cost possibility is respectively specified in order to coat different variants of material blanks 2 particularly efficiently with the adhesive 3. Here it is provided in particular that a large part of the activities that lead to the finished material blank 2 coated with the adhesive 3 are performed in a mechanically supported manner, in particular automatically. Thus it is conceivable, for example, that a (human) worker places the initially uncoated material blank 2 in the spray device 1 at the input side 24 without having to pay attention to an orientation of the material blank 2. Because in particular using the scanning bar 16, during the recording of the blank feature 10 the positional location or orientation of the material blank 2 on the conveyor belt 13 is determined and—for example as part of the blank feature 10—provided to the control device 4. It is thus provided that the material blank 2 is sprayed with the adhesive 3 in a contour-precise manner no matter how the material blank 2 is oriented on the conveyor belt 13.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A spray device for spraying a material blank with an adhesive, comprising:
a control device;
a scanning device configured to record a blank feature that characterizes the material blank to be sprayed, and to provide a corresponding blank-feature data set to the control device;
a conveyor belt configured to move the material blank to be sprayed along a conveying direction of the conveyor belt through a spray region of the spray device; and
a plurality of spray nozzles directed into the spray region configured to spray an adhesive onto the material blank as the material blank is moved through the spray region, the plurality of spray nozzles are controllable by the control device based on the corresponding blank-feature data set, and the plurality of spray nozzles are configured to generate on the material blank an adhesive layer, which is formed based on the blank feature.

2. The spray device according to claim 1, wherein the scanning device includes an external scanning unit configured to record the blank feature.

3. The spray device according to claim 1, wherein the scanning device includes an internal scanning unit configured to record the blank feature.

4. The spray device according to claim 3, wherein the internal scanning unit includes a straight scanning bar that is arranged perpendicular to the conveying direction over the conveyor belt and at an input side of the spray device before the spray region.

5. The spray device according to claim 1, wherein the plurality of spray nozzles are controllable using the control device based on the corresponding blank-feature data set such that one or more spray parameters for the adhesive layer to be generated by the plurality of spray nozzles is adjustable, and the one or more spray parameters include a material-blank region to be kept free of adhesive, an amount of adhesive per surface portion of the material blank, an adhesive spray pressure, and an adhesive spray temperature.

6. The spray device according to claim 1, further comprising a straight spray-nozzle bar on which at least two first spray nozzles of the plurality of spray nozzles are disposed, the at least two first spray nozzles are spaced equidistant from one another along a longitudinal extension direction of the straight spray-nozzle bar, and are arranged perpendicular to the conveying direction over the conveyor belt.

7. The spray device according to claim 6, further comprising a second straight spray-nozzle bar, wherein the straight spray-nozzle bar and the second straight spray-nozzle bar are offset with respect to each other and are perpendicular to the conveying direction such that between the at least two first spray nozzles of the plurality of spray nozzles that are directly adjacent to each other on the straight spray-nozzle bar, a second spray nozzle of the second straight spray-nozzle bar is arranged.

8. The spray device according to claim 1, wherein at least one spray nozzle of the plurality of spray nozzles includes a nozzle outlet that is configured such that a spray cone is formed in a predetermined distance from the nozzle outlet, and a diameter of the spray cone measures between 1 mm to 4 mm.

9. The spray device according to claim 8, wherein the diameter of the spray cone measures between 2 mm to 3 mm.

10. The spray device according to claim 1, wherein the blank feature comprises a plurality of partial features of the material blank and the scanning device is configured to record at least one partial feature of the plurality of partial features, and the plurality of partial features includes an outer-circumference contour of the material blank, an opening contour of an opening penetrating the material blank, and a code arrangement of the material blank.

11. The spray device according to claim 10, wherein the code arrangement includes a plurality of code elements, the scanning device is configured to record at least one of the plurality of code elements, and the plurality of code elements include an edge-notch arrangement including at least one edge notch, a barcode, and a QR code of the material blank.

12. The spray device according to claim 1, further comprising a hot-air blower arranged at an output side of the spray device behind the spray region.

13. The spray device according to claim 12, further comprising a cold-air blower arranged at an output side of the spray device.

14. The spray device according to claim 13, wherein the cold-air blower is arranged behind the hot-air blower.

15. The spray device according to claim 1, further comprising a drying device arranged at an output side of the spray device behind the spray region to dehumidify the adhesive layer.

16. A method for spraying a material blank with an adhesive using a spray device configured according to claim 1.
